(19) United States
(12) Patent Application Publication
(10) Pub. No.: US 2010/0136509 A1
(43) Pub. Date: Jun. 3, 2010

(54) SYSTEM AND METHOD FOR CLINICAL TRIAL INVESTIGATOR MEETING DELIVERY AND TRAINING INCLUDING DYNAMIC MEDIA ENRICHMENT

(76) Inventors: Alden Mejer, Los Angeles, CA (US); Dave Young, North Hollywood, CA (US)

Correspondence Address: Deborah Neville, P.O. Box 61063, Palo Alto, CA, 94306, US

(21) Appl. No.: 12/452,363

(22) PCT Filed: Jun. 30, 2008
(86) PCT No.: PCT/US08/08144

§ 371 Date: Dec. 28, 2009

Related U.S. Application Data
(60) Provisional application No. 60/958,062, filed on Jul. 2, 2007.
(60) Provisional application No. 60/958,054, filed on Jul. 2, 2007.

(51) Int. Cl. G09B 19/00

(52) U.S. Cl. 434/219

(57) ABSTRACT

A System and Method for Delivering the substantive equivalent of an Investigator Meeting for Clinical Tπals to satisfy Investigator Site training requirements sufficient to commence patient enrollment is provided The invention further provides a means to ensure site personnel receive, review and implement Protocol Amendments in a timely and comprehensive manner The preferred embodiment includes a mechanism to track and verify actual viewing of compulsory material The invention further provides for dynamically supplementing the online presentation with content enrichment In the preferred embodiment, user questions are submitted during user viewing of online media An Administrator processes user inputs, including questions, and answers attached to the presentation at the time point at which the question/comment was generated Subsequent users/viewers are alerted to the added commentary by an icon on the display during viewing of presentation media, enabling them to benefit from questions and answers associated with the media.

### RELATED APPLICATIONS

This application claims priority from U.S. provisional applications 60/958,062 and 60/958,054, both filed Jul. 2, 2008; and the entirety of both are incorporated by reference as if fully set forth herein.

### FIELD OF USE

The field of use is generally computer assisted training, including networked computers and particularly, computers connected via the Internet. More particularly, the field of use is training of Investigators for Clinical Trials of drugs or medical devices.

### BACKGROUND

Medical innovations, including new drugs and medical devices are required to be researched and tested by means of clinical trials. There are typically four phases for clinical trials, with each phase designed to answer a separate and distinct research question. The scope of testing expands with each phase.

Phase 1: Testing a new drug or treatment in a small group of people for the first time to evaluate its safety, determine a safe range of doses, and identify any side effects.
Phase 2: In this phase, the drug or treatment is given to a larger group of people to determine its efficacy and to further evaluate safety.
Phase 3: Large groups of people are given the drug to confirm its effectiveness, monitor for any side effects, compare it to commonly available and proven treatments, and collect more information about the drug that will allow safe use.
Phase 4: These trials are done after the drug or treatment has been marketed to gather information on effects in various populations and any side effects associated with long-term use.

The trial sponsor recruits medical centers and clinics, also known as “sites,” to participate in the trial. Each site has Investigators and Coordinators who will be responsible for conducting the trial at their facility. Each site is responsible for identifying and enrolling patients who meet the inclusion criteria for the current phase of the trial and then treating those enrolled patients in accordance with the Protocol for the trial.

The protocol contains all of the rules that all clinical research sites must follow during the trial and outlines the criteria that eligible patients must meet in order to be enrolled in a study. The protocol also provides the schedule, procedures, medications, dosages, and the length of the study.

In order to participate and enroll patients in a specific phase of a Clinical Study or Trial, the Investigators and Coordinators from each site that will work on the trial must physically attend an “Investigator” and/or “Coordinator” Meeting where they are familiarized with the protocol for the study or trial and are exposed to mandatory training in areas such as Good Clinical Practice, Serious Adverse Events, Regulatory Compliance, and other related topics. This meeting is where the pharmaceutical sponsor of a study brings together participating Investigators and Coordinators to review the trial procedures and activities and provides an opportunity for questions and clarification. Attendance at one of these meetings is mandatory and is required to fulfill regulatory requirements. A site cannot begin enrolling patients until the site personnel responsible for participating in the study have attended a meeting and received their training.

If a site cannot participate in the Investigator Meeting, a Site Initiation Visit is conducted, and a Monitor attends the site and reviews the trial procedures with the personnel at the site. The purpose of the Investigator Meeting or the Site Initiation Visit is to acquaint all site personnel with the relevant aspects of the study prior to any participant enrollment and involves the review/discussion of the following: protocol, case report form completion, missed visits, Institutional Review Board/Independent Ethics Committee (IRB/IEC) reporting requirements, adverse event reporting and various other aspects of the trial.

The amount of time consumed is one problem with the current practice of requiring Investigators and Coordinators physically attend an Investigator's Meeting or having a Monitor visit a site to perform site training. Any delays in getting the Investigators and site staff trained on the protocol and trial procedures results in delays in enrolling patients and such delays are ultimately reflected in the amount of time it takes to complete a clinical trial.

Each of the four Clinical Trial phases enrolls greater numbers of patients, is more time consuming and is, therefore, more expensive. Completion of all four phases can take as long as 10 to 15 years. Many products fail. The high cost and low likelihood of success makes it important that patients be enrolled in each phase of the clinical trial as soon as possible, and thereby shorten the time to phase completion.

The more quickly patients can be enrolled, the more rapidly the results of the phase will be known and subsequent phases started or the drug or medical device abandoned before additional capital is expended. Each day of delay in clinical trial completion poses millions of dollars in losses to drug companies. On average, and depending on the phase of development, most trials last 30%-42% longer than originally scheduled. A report issued by the FDA in 2004 “Innovation, Stagnation, Challenge and Opportunity on the Critical Path to New Medical Products” indicated that a drug company can expect only 8% of new medical compounds entering first phase trials will make it through the approval process and into the market. Thus efficient completion of each phase is critical to cost effective clinical trials.

Site training and patient enrollment consume a significant amount of time in completing each clinical trial phase. Trials are frequently delayed because sites cannot be trained quickly, and patient enrollment commenced. In some trials, if a site does not enroll a first patient within a specified period of time after attending an Investigator Meeting, a mandatory Site Initiation Visit is required. Typically, the scheduling of the Site Initiation Visits is more time consuming than the visit itself, owing to time consumed in reconciling schedule conflicts and other logistical and administrative chores. What is needed is a Site Training process that permits a site to commence enrolling patients without the need for a Site Initiation Visit.

Often times, after the trial Protocol has been created and the trial has commenced, Protocol Amendments may be issued in light of experience gained during the trial. These Amendments are changes or clarifications to the original Protocol. Each initiated site must be apprised of Protocol Amendments as soon as possible and all participating site personnel must review the Protocol Amendment and use the amended Protocol once the governing Institutional Review Board approves the amendment. Currently, there is no convenient way to determine whether personnel at a given site have received and reviewed the Protocol Amendment and, most importantly, at what point the site commenced implementation of the amended protocol. What is needed is a means to rapidly communicate and track review of Protocol amendments by site personnel, enabling both accurate tracking of implementation and superior analytics of clinical trial data.

Substantive Equivalent of Investigator Meeting. It can be appreciated that attendees at a live Investigator Meeting may ask questions and receive answers as material is presented during the meeting. To construct a substantive equivalent to a live training meeting, the contextual feature of interactivity must be offered. While media systems for re-playing live events may permit questions and input to be entered and submitted by the user, current systems do not associate the user-submitted input with the time point in the content when the user actually initiated the question or input. The user asked a question or submitted input based on something contained in the content. Their question or input was triggered by something they saw or heard. The question or input submitted might only be relevant to the time point at which it was initiated or at the very least may only be understood in the context of the material that triggered the question.

Moreover, Administrators or Subject Matter Experts who are required to answer the question need to have a complete understanding of the question that has been asked and to facilitate this, they need to be able to easily locate and review the material that actually triggered the question. Administrators or the content creators require feedback to help them clarify or enhance the areas of the content that generate the most questions. Areas of content that are ambiguous (or perhaps even incorrect) need to be quickly and easily identified. Current systems do not enable an association between user question and the time point at which the user question was initiated or submitted. Nor are Administrators or Subject Matter Experts provided the time point information to actually view the materials at the point on the timeline that the user question or input was initiated. What is needed is a means of associating a user question with the media presentation material on display at the time the user initiated a question or comment.

In addition to viewer submitted questions and other information, internal users such as Trial Managers, Statisticians, or others may wish to associate some form of interactive content at a specific point on the timeline. This content may take the form of quiz questions, survey questions, participatory questions, clarification materials or corrections to the existing content. In this case, the interactive content must also be associated to the multimedia timeline at the appropriate location. The benefit of allowing these different types of materials to be associated with the timeline, rather than being embedded in the original content is a high degree of flexibility. Interactive content can be associated to the timeline at any time, even after the original content has been released. It can also be easily moved if required which eliminates the need to re-edit or re-produce the original content.

In the case of user submitted questions, Administrators require the ability to publish the response in one of several ways. Some questions or input are not suitable for publication due to their nature. In these cases, the Administrator requires the ability to send a response only to the individual who submitted the question or input. In this case, an email or other transmission would be sent to the person who submitted the question or input and the question and response would not be made available to anyone else. In other cases, the Administrator may feel that the question or input and the response should only be available as a static Frequently Asked Question (FAQ). The question and answer would be made available to all subsequent users of the material but the user would have to navigate to where the FAQ's are located and access the question or input and the published response. In another alternative implementation, the Administrator may want to make the question or input and response available to all subsequent viewers as an interactive part of their viewing experience. Ideally, a system would provide subsequent viewers a means to dynamically see that a question was asked while they are watching the content and be alerted to that fact by a graphical or textual indication that there was a question or input and a response at the exact point in the timeline when the original question or input was initiated or submitted. The viewer could then choose to ignore the question and the response, or could elect to pause the training and review the question and the response that was submitted. Current systems do not afford an Administrator these capabilities to dynamically enrich a media presentation to users over a network. Moreover, current systems do not afford users choice concerning inclusion of dynamic supplemental material, including comments and clarifications, in the media consumption experience.

What is needed is a system and method of dynamically enriching media presentation distributed over a network to users. What is also needed is a method of associating user comment with the portion of the presentation material on display at the time the user comment was created. What is further needed is a means of flexibly presenting user options to review supplemental material provided through the Administrator or Subject Matter Expert such that users can adaptively avail themselves of training material.

### SUMMARY OF THE INVENTION

The invention taught herein meets at least all of the needs recited hereinabove. The invention provides an alternative to compulsory attendance at an Investigator Meeting or a Site Visit in order to commence patient enrollment in Clinical Trials. The system and method delivers the same material that an Investigator or Coordinator would receive had they attended an actual meeting. For those Investigators and Coordinators who cannot attend a meeting, the system provides a far more consistent training than is possible with one-off site visits.

The system monitors each user in such a way as to ensure that the user is actually present and attending to the content and training materials.

The invention allows users to meet all of the information viewing requirements necessary for participating in a Clinical Trial. Users can arrange the training at their convenience. As a User's attendance to content and required training material is monitored and completion recorded electronically, upon completion of the online training, a User—or Site—can immediately commence patient enrollment in the study or trial.

Moreover, the system and method provides delivery of any Protocol Amendment over the network, and tracking of each users attendance to the material delivered to a) ensure that all of the materials have been completely viewed and b) record data concerning implementation of Protocol Amendment at the Investigation Site.

The invention further provides for interactively collecting questions or other input from users at user selected time points during a training session delivered over a network. The system allows users who are viewing the training to interactively ask a question or submit input that is time stamped at the time point that the user elects to ask the question or provide the input. The system stores the information about the question or input including but not limited to the content being viewed, the user who entered the input, the time point that the input was initiated along with the actual input in a database.

In a preferred embodiment, questions and answers are published and reference the time point in the training that a user input the question. Subsequent viewings of the training materials display a graphical or textual indication that a question was asked at that point in the timeline and the system allows the user to view—or hear—the question and the answer. If there are multiple questions asked within a small, defined period of time (e.g. 5 seconds), the system displays all of the questions and answers for the period together to prevent excessive interruptions to the user.

The configurable system provides highly tailored presentation and interactivity, according to user role, training objective, user behavior, jurisdiction (by state or country), and other governable factors.

The invention provides that all user input is captured at the time it occurs and is available immediately. Administrators can monitor the results of interactive responses to determine how the training is proceeding in near real-time. This allows the incoming data to be analyzed and reviewed for possible changes and allows administrators to see how users are responding to the interactive content.

If interactive content is changed, the system creates a new version of the content and keeps track of which version new users will be displayed along with the questions that were displayed to users who interacted with the previous version of the content. In this way, administrators can keep track of which version of the content individual users have responded to, thus ensuring accuracy and proper context when analyzing the responses.

### BRIEF DESCRIPTION OF THE DRAWINGS

FIG. 1 is a flow chart depicting clinical trial process incorporating the inventive system and method.

FIG. 2 depicts a generalized overview of a networked system implementation of the invention taught herein.

FIG. 3 is an example of a user display screen provided by the player according to the invention.

FIG. 4 is an example of the layout of a display screen provided by the player according to the invention.

FIG. 5 is a flowchart depicting an implementation of the “ask question” method according to the invention.

FIG. 6 is a flow chart depicting an implementation of “answer question” and “publish answer” method according to the invention.

FIG. 7 is a flowchart depicting interactive FAQ according to the invention

FIG. 8 is an exemplar of a user display depicting “Player—ask question” according to the invention.

FIG. 9 is an exemplar of a user display depicting “Player—enter and submit question” according to the invention.

FIG. 10 is an exemplar of a user display depicting “List of Questions to be answered” according to the present invention.

FIG. 11 is an exemplar of a user display depicting “Answer Questions” according to the invention.

FIG. 12 is an exemplar of a user display depicting “Interactive FAQ during Viewing” according to the invention.

FIG. 13 is an exemplar of a user display depicting “View question and published answer” according to the invention.

FIG. 14 is an exemplar of a user display depicting “Static FAQ” according to the invention.

### DETAILED DESCRIPTION OF THE PREFERRED EMBODIMENT

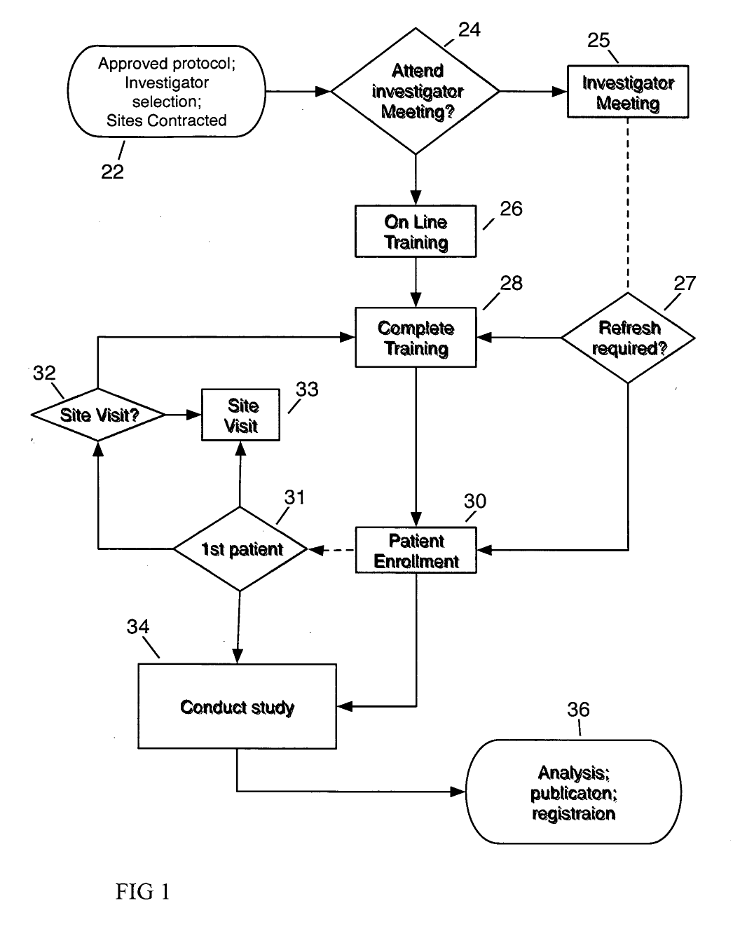

FIG. 1 depicts the inventive method of satisfying the training requirement for clinical trial site participation. By providing the precise equivalent of any required Investigator meeting, and by ensuring all site personnel have complied with receiving and reviewing all required material, the inventive method expedites commencement of clinical trial patient enrollment, and ensures compliance with protocol amendments by a site. At the inception of a clinical trial, an approved protocol proceeds to Investigator Selection and Contracting Sites 22. To satisfy the required training prior to commencing patient enrollment, personnel at a Contracted Site may elect to attend an Investigator Meeting 25 or register for online training 26 according to the invention. After a Site has completed training 28, the Site may commence to Recruit & Enroll Patients 30, and proceed to conduct the study 34. If the study has a provision for initial patient enrollment within a defined period 31, for example, a Site Initiation Visit 32 or a Monitor Site Visit 33 may be required to deem that Training is Complete 28. The invention provides that the completion of training may be satisfied in whole or in part by computer implemented training. After Conducting the Study 34, post study activities 36 may ensue including statistical analysis, reporting and publication of results, and, if successful, filing data and obtaining registration.

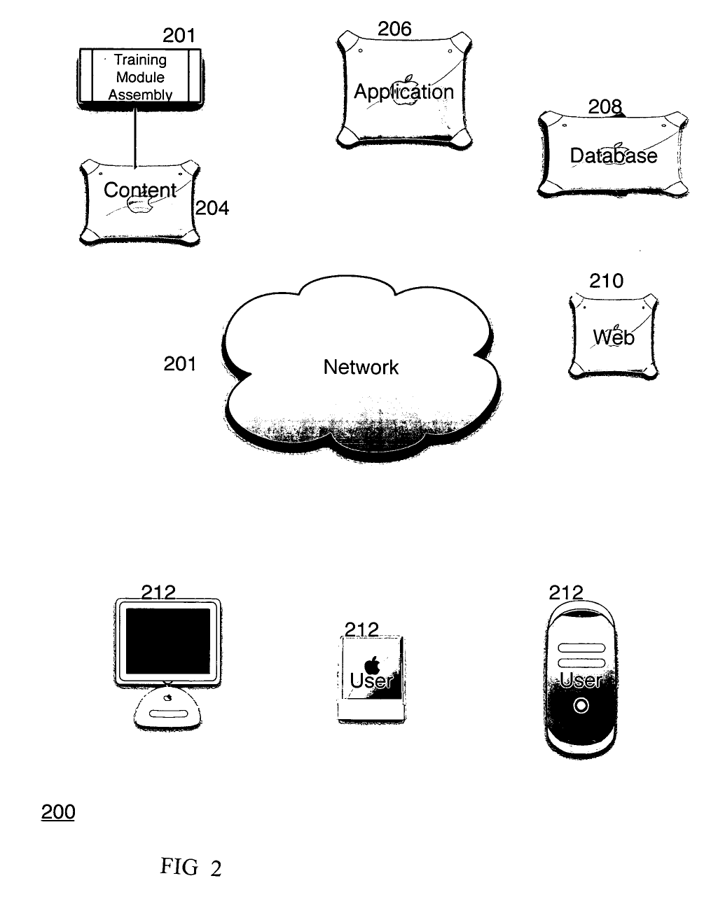

FIG. 2 generally depicts a system 200 for implementing the method according to the invention, including a network 201, intranet or extranet, and including one or more of each of the following: a training module assembly 202, Content server 204, Application server 206, Database server 208, Web server 210 and user devices 212. Training module assembly is predicated on a number of processes. According to the preferred embodiment, training materials for the study or trial are captured using existing video capture technology along with any supporting presentation materials that accompany the video. Presentation materials can include images, web sites, presentations, documents, or any other form of supporting materials. The video capture can be done at a live event or staged at a production facility. In the preferred embodiment, the video capture is done at a first Investigator Meeting. Capturing an actual meeting is a cost effective means of leveraging the time and expenditure of the meeting and allows the study sponsor to reuse the material for the online system.

The video and presentation materials are then edited and cleaned up and then converted into an appropriate digital format that is compatible with streaming or downloading across a network. The video and presentation materials are then combined using existing technology into a synchronized training module that can be streamed or downloaded across a network to a user's device.

Training module assembly 202. All of the modules that make up the training are entered into the system 200. The system organizes the required training into training segments that are ordered in a prescribed sequence. In most cases, the materials are organized as they would be delivered or were delivered at the Investigator and/or Coordinator meeting. As used here-in and according to the invention, training material is the substantive equivalent of attendance at an Investigator Meeting, and may also be referred to as “required training” of the like.

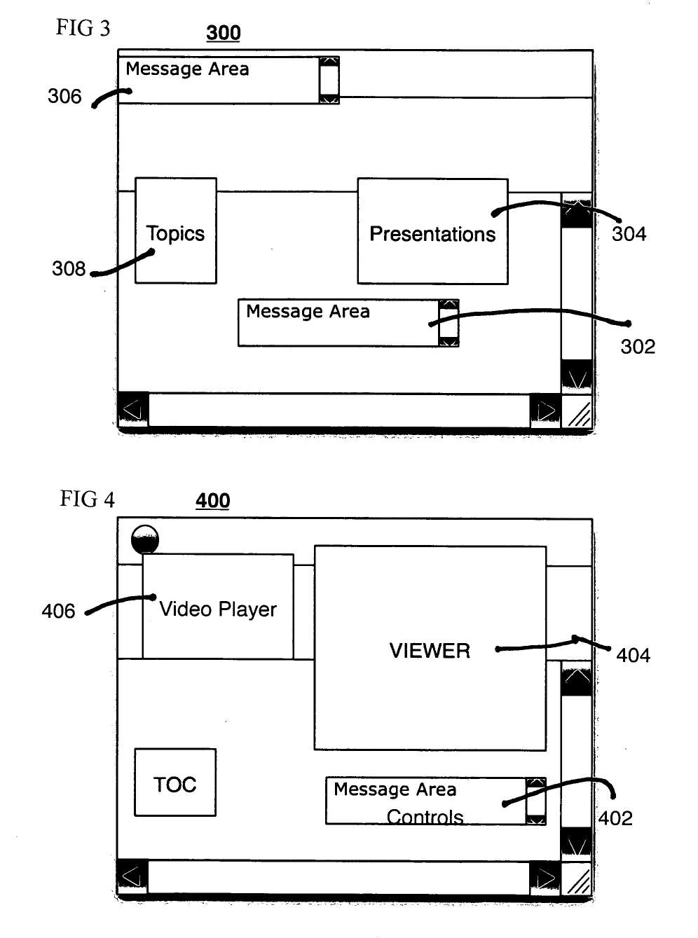

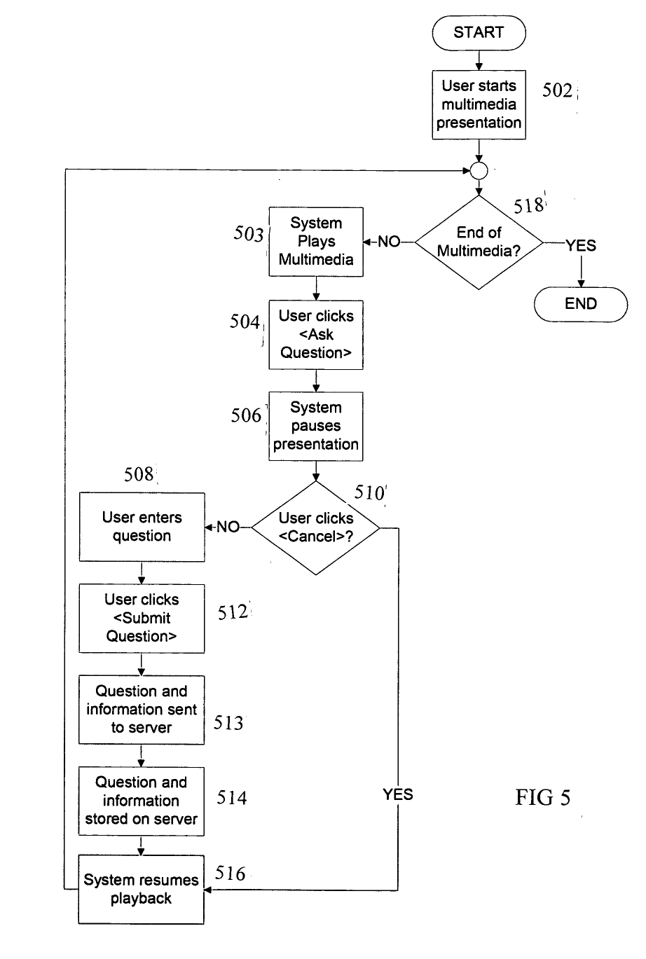

The system provides two user-facing components, the Launcher and the Player, depicted in representative schematics of user interface displays in FIG. 3 and FIG. 4, respectively. After user log-in, the system displays the Launcher 300, which displays the Topics 308 and the Presentation materials 304, and one or more text or message areas 306, 302. The Launcher displays the training material in a logical grouping—Topics 308—that makes it easy for the user to see and understand the training material as a whole and the viewing sequence, and aid the user in managing the training session. In the preferred embodiment, the user's progress is tracked and displayed as a percentage of the training completed (not shown).

A visual indicator beside each Presentation indicates whether the training module has not been started, has been started, or has been completed. The user initiates viewing of material from the Launcher page. In the preferred embodiment, a user elects (by means of some action, such as a mouse-click, vocalization, etc.) to commence training whereupon the system automatically launches the Player 400.

A representative schematic of the Player 400 user interface is depicted in FIG. 4. The Player delivers to the user the video of a live meeting and the associated presentation material (i.e. slides.e etc.) that comprise at least the required training. The player is comprised of these elements: Video Player 406—a window that displays the video for the module; Controls 402—the controls that allow a user to navigate and control the playback of the training materials; Viewer 404—a window that displays the presentation materials that are associated with the video delivered through the Video Player 406, and can include any type of supplemental material in any media form (e.g. PowerPoint Slides, Images, Web Pages, etc.; and a Table of Contents (TOC) 408—a list of the presentation materials. Also in the preferred embodiment (but not depicted) are time index and search features. The user can select the time index in the presentation that they wish to view. These can be considered “chapters” in the training module. A user can search for keywords in the training to locate and go to a specific time index in the training.

In an alternate implementation, multiple registered users can log into the system together and conduct their training as a group with each person receiving individual credit for having completed the necessary viewing requirements. In this implementation, the system requires each person in the group to individually sign in together and requires the organizer of the group to verify that each person signing in is present and will remain present for the duration of the training. Each user can conduct their viewing at their convenience, without disrupting their regular duties or work schedules. This allows Investigators and Coordinators the advantage of receiving their training at a convenient time. Each user can choose to conduct their training over multiple sessions that span a period of hours, days, or longer. If a user elects to conduct training over multiple sessions, the system keeps track of the user's last viewed position and when the user restarts training, the system automatically takes the user to the last viewed position. This eliminates the need for the user to remember where they were, and they can simply let the system restart their training at the appropriate location.

As each person receives the training, the system tracks and records their viewing completion status for each required training module to ensure that all materials have been viewed in order to meet regulatory requirements. The system uses a regulatory approved monitoring system to ensure that users are in fact at the computer and are viewing the materials. Related application PCT/US08/02599 teaches use of a WatchCode. The WatchCode ensures actual viewing of the materials, rather than merely playing the materials. The system provides the trial sponsor with an indication of how quickly the sites are completing the training and when patient enrollment can commence.

After the user being trained has viewed all of the required materials, the system generates a completion certificate and keeps an audit trail that the person has completed all training requirements. The user can print the certificate and keep it on file to prove training completion.

In an alternative implementation, a user can be trained using the online system and later attend an Investigator Meeting. In this alternative embodiment, the user arrives at the Investigator Meeting having already been exposed to the material, and, consequently, better able to ask relevant questions and provide feedback regarding the trial protocol,

Protocol Amendments. As the trial is being conducted and real world experience is gained regarding the Protocol, the study sponsor develops amendments to the Protocol and issues those amendments to the participating sites. Each participating site is advised that all study personnel must log back into the system and completely view the amendment in order to receive an updated certification for the trial.

Each site personnel participating in the site logs into the system, reviews the Protocol Amendment content and the system tracks their completion status. After they have completed viewing the amended Protocol, the system re-certifies that the person has completed their required training. All of the completion information is stored and is available to the study sponsor at any time. The study sponsor may use that information to determine when the site should have begun using the amended Protocol. Using this system provides an accurate record of when each site was trained on the amended protocol and eliminates any ambiguity about when that site should have begun using the amended protocol.

The invention further provides for interactively collecting questions or other input from users at user selected time points during a training session delivered over a network. FIG. 5 is a flow chart illustrating, according to a preferred embodiment, the steps of interactivity: User starts the training (e.g. a selected multimedia presentation) 502; System plays selection 503; User selects or clicks “ask question” button 504 on GUI; System pauses the presentation 506; User enters question 508; User submits question 512 (or clicks cancel 510 whereupon system resumes playback 516); Question and related information sent to server 513; system stores the question and related information 514; system resumes presentation 516 until completed 518. The system allows users who are viewing the training to interactively ask a question or submit input that is time stamped at the time point that the user elects to ask the question or provide the input. The system stores the information about the question or input including but not limited to the content being viewed, the person who entered the input, the time point that the input was initiated along with the actual input in a database.

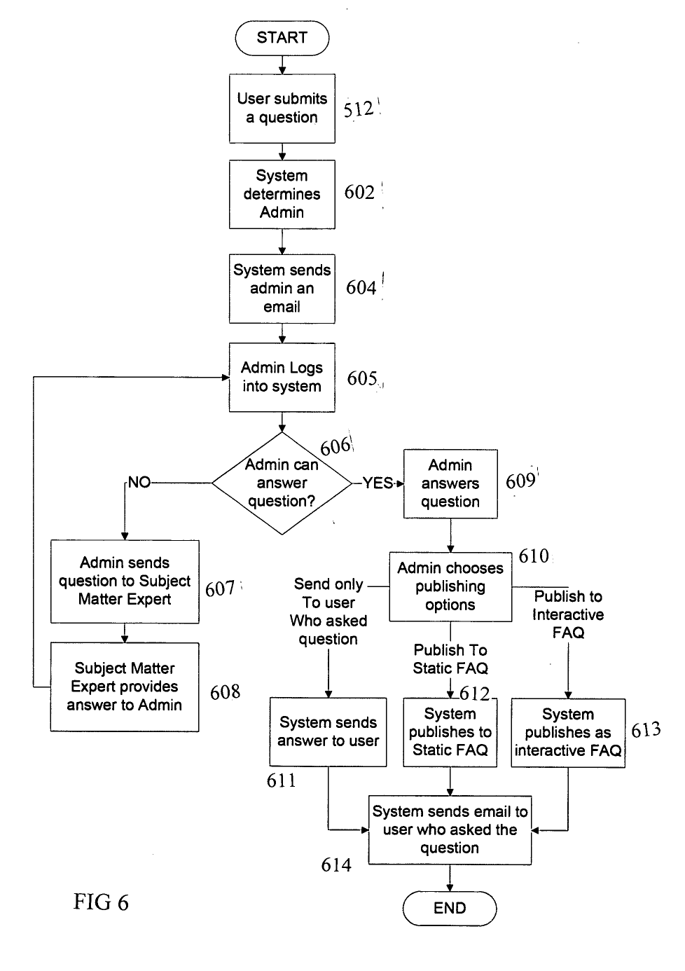

The input is then sent to one or more administrators assigned to the content for a response. FIG. 6 depicts the steps, according to the preferred embodiment, of responding to user input, such as questions. After a user submits a question 512, the System determines which Administrator should receive the submission 602 and sends Administrator an email 604 or other notification. When Administrator logs into System 650 and reviews question, Administrator determines if Subject Matter Expert is appropriate, and if so, sends question to Subject Matter Expert 607, and Subject Matter Expert provides answer to Administrator 608. If no Subject Matter Expert is needed, the Administrator may undertake to answer question 609. Once the Administrator has an answer to the submitted question, he/she chooses publishing option 610 as follows: a) Publish to static FAQ 612—publish the question and answer to the static FAQ list that is available on the system—; Users who want to review FAQ's must explicitly navigate to the FAQ area and review the FAQ's of interest; b) Publish to interactive FAQ 613—make the question and answer available to all subsequent users of the system and will display a graphical or textual indication at the time point that the question was originally asked while the user is viewing the content; c) respond only to the user who submitted the question 611—sends the original question and the response in an email only to the person/user who originally submitted the question.

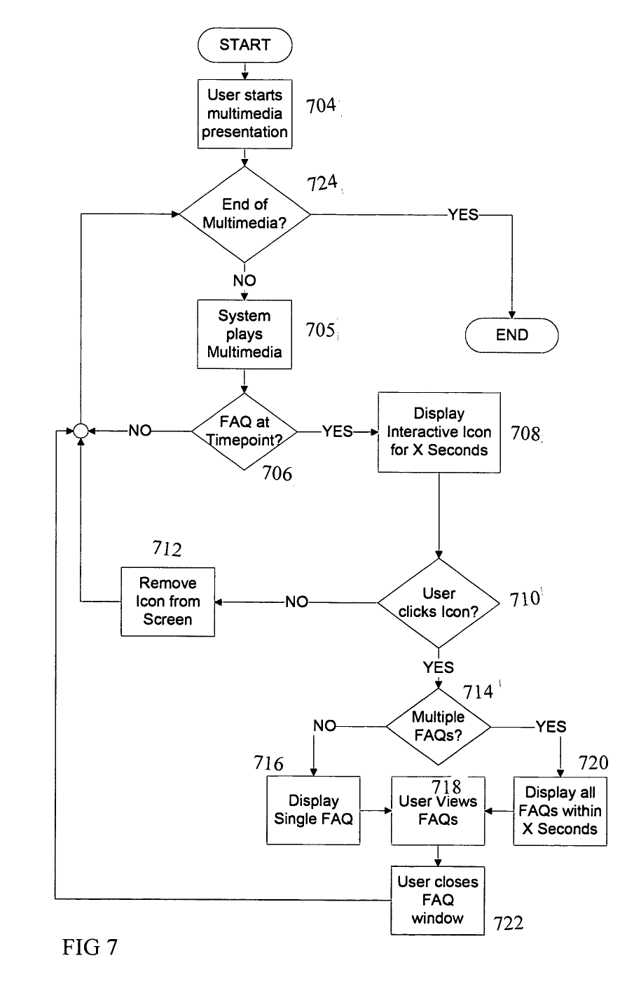

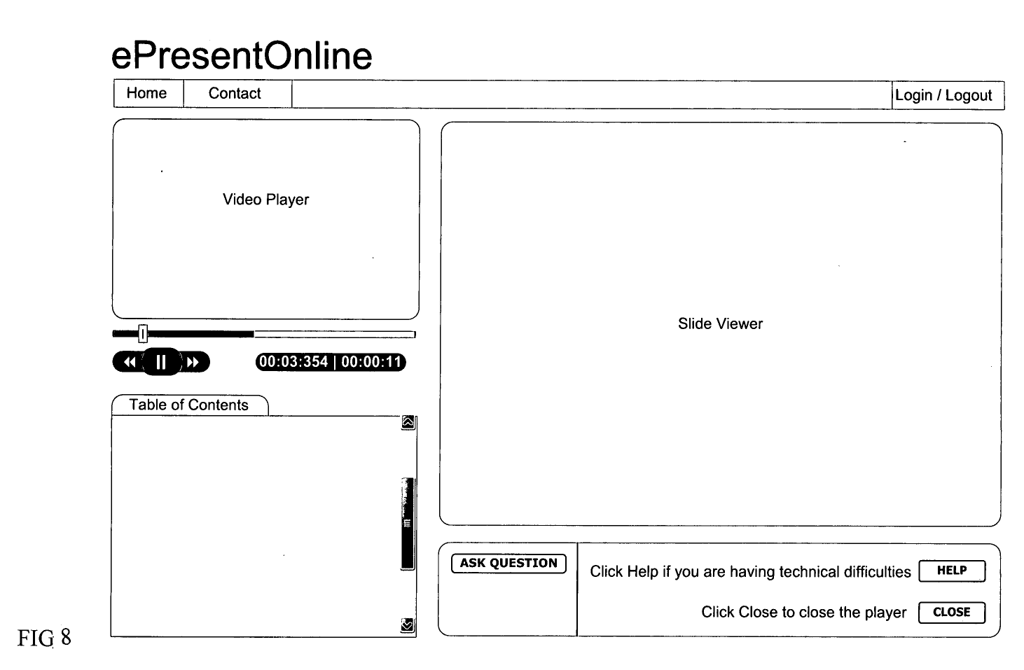

FIG. 7 depicts a flow chart of the steps of viewing interactive FAQ as provided by the invention. A User starts a multimedia presentation 704; the system plays selected multimedia 705 and determines if there are any FAQ at timepoint 706; if yes, system displays Interactive Icon 708; User then may click Icon 710, and view a single FAQ 716, or, if multiple FAQ 714, system will display all FAQs within X seconds 720—some range of time in the presentation timeline. After user views FAQ 718, User may close FAQ window 722, and resume playback and FAQ display at timepoints and so on until the end of the multimedia 724.

Exemplar renderings of the GUI/screen shots in the preferred embodiment further depict the interactivity according to the preferred embodiment in FIGS. 8-14.

PLAYER—ASK QUESTION (FIG. 8). The user views the training using the component of the system known as the Player (as in FIG. 4). While the user is viewing a training session, the system displays an <Ask Question> button in the Message and Controls area. The user can click the <Ask Question> button at any time during the session.

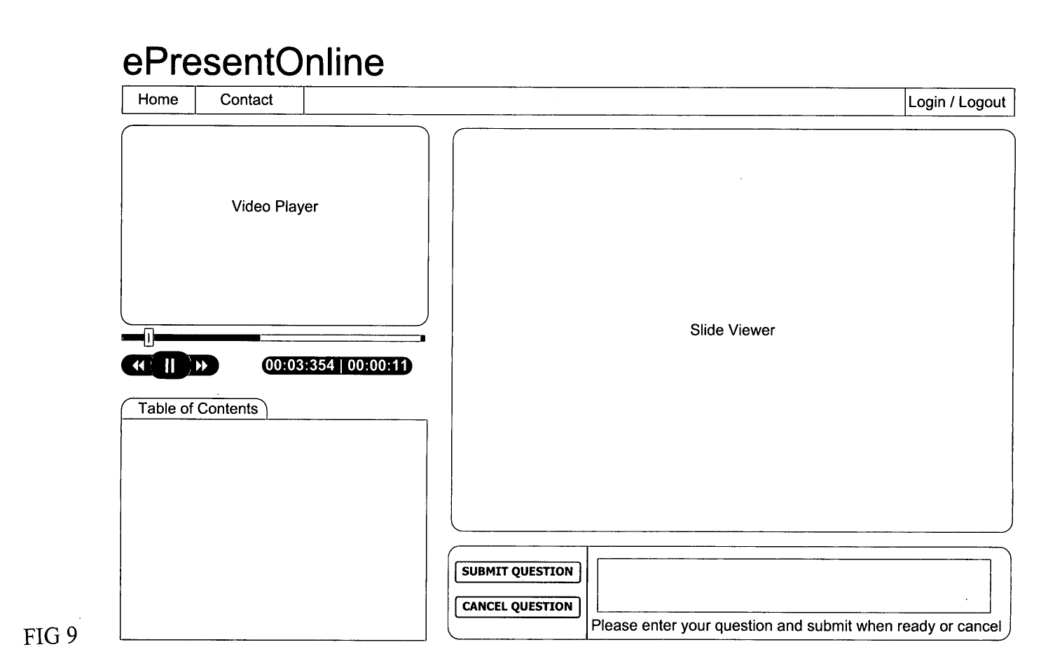

PLAYER—ENTER AND SUBMIT QUESTION (FIG. 9). When the user clicks the <Ask Question> button in the Message and Controls area, the system performs the following actions: pauses the playback of the video and presentation materials; Captures the time point in the training timeline that the <Ask Question> was clicked; displays a <Submit Question> button and a <Cancel Question> button; displays a free format text data entry box where the user can type or otherwise enter a question. The user can click the <Cancel Question> button to cancel and return to the material being viewed. Once the user has entered the question, and clicked the <Submit Question> button, the system may perform the following actions: a) store the question, the user who asked the question, the training module for which the question was asked, and the time point in the training when the question was asked; b) send the user an email with the question information and confirming that the administrator has been notified; c) sends an email to the administrator with the question information and a message to log into the system to answer the question; and d) resumes playing the multimedia presentation.

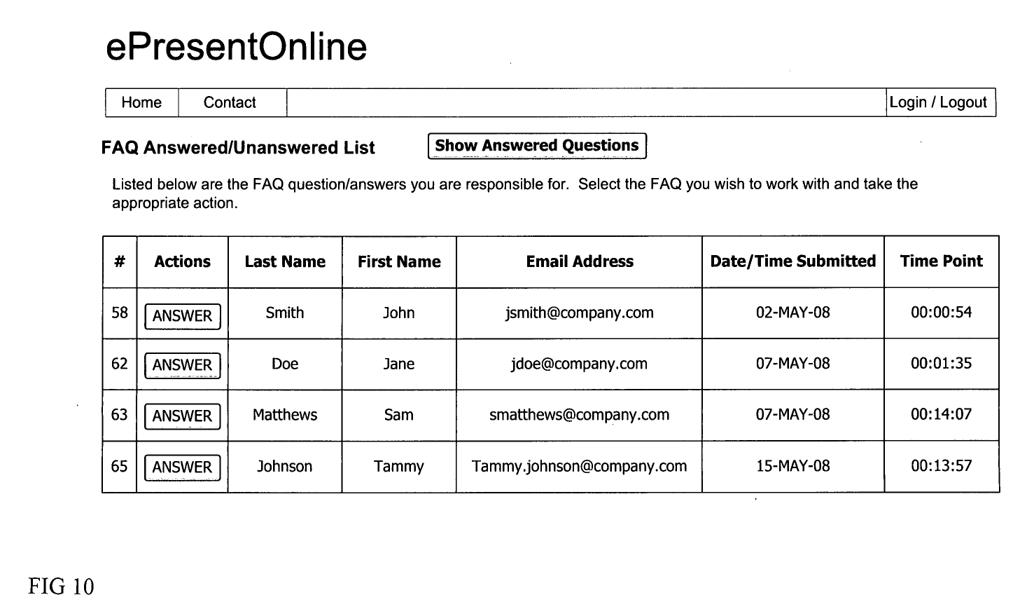

LIST OF QUESTIONS TO BE ANSWERED (FIG. 10). A Question Administrator logs into the system to see the list of questions that have been asked, shown as items 54-59 in the figure, and can select questions to answer. Note: the Time Point—the point in the presentation each question was submitted—is also displayed.

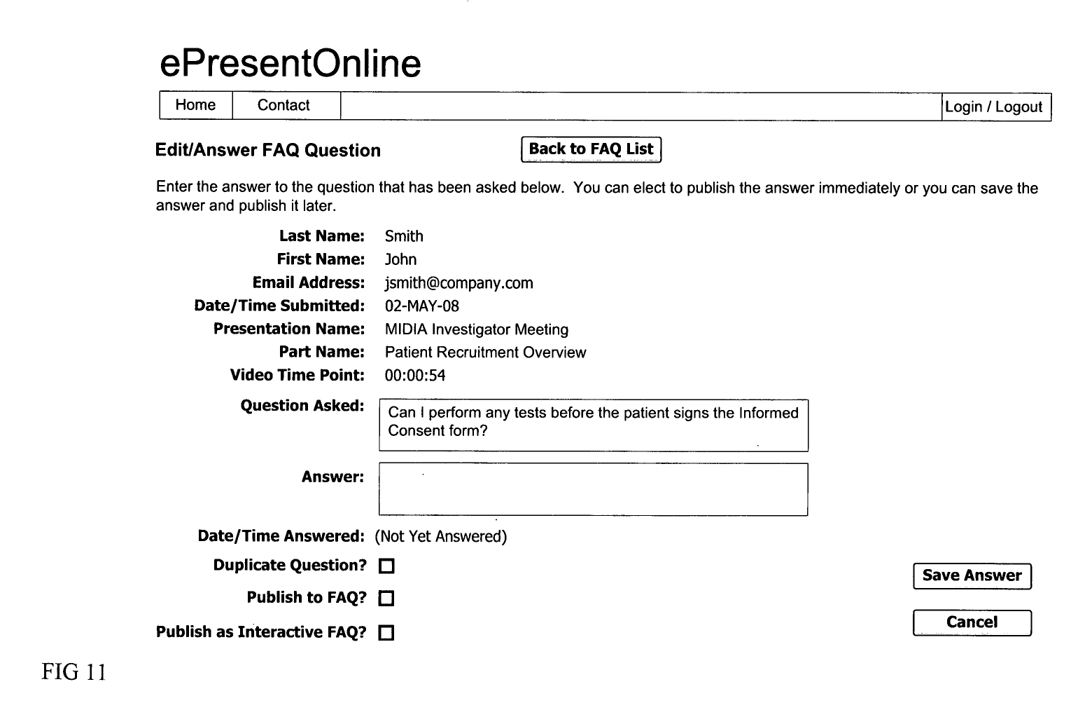

ANSWER QUESTION (FIG. 11). A system Administrator can answer the question that was submitted or refer it to a Subject Matter Expert. The Administrator publishes the answer and the person who asked the question receives an email with the answer to their question. The Administrator decides whether the question and answer should be published as static FAQ content, as an interactive FAQ, or sent only to the user who submitted the question.

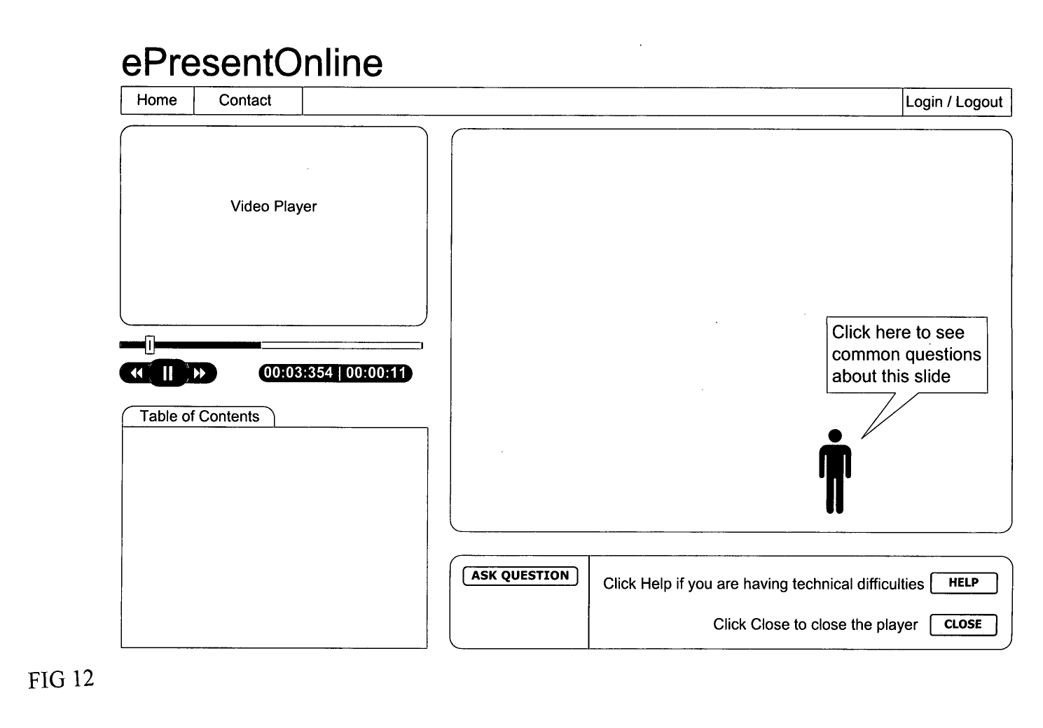

INTERACTIVE FAQ DURING VIEWING (FIG. 12). If the Interactive FAQ has been enabled for a question, at the time point on the timeline where the original question was asked, the system displays a graphical or textual indication that one or more questions were asked at that timepoint.

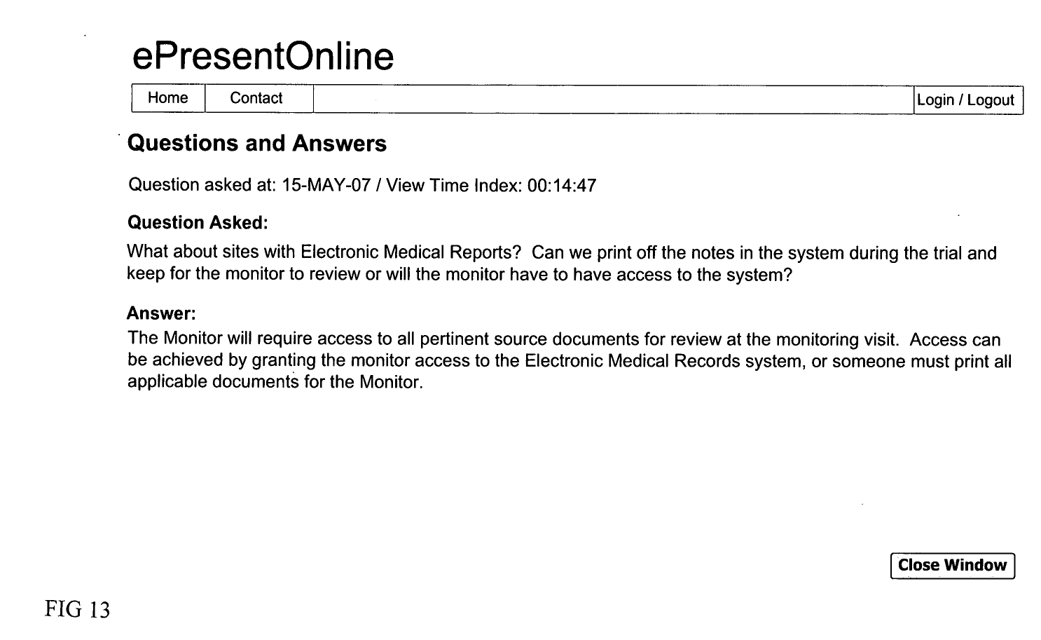

VIEW QUESTION AND PUBLISHED ANSWER (FIG. 13). When the current viewer clicks on the graphical image or text to view the question that was asked or the user clicks on the static FAQ link, the system displays the question that was asked and the answer that was published.

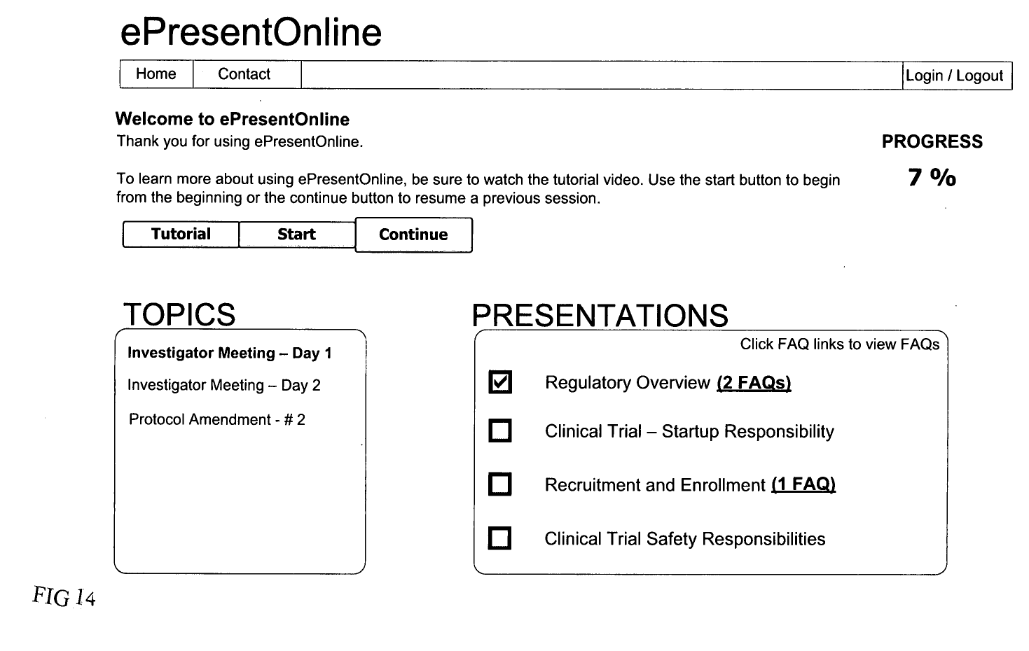

DISPLAY STATIC FAQ (FIG. 14). If the Administrator has selected the Publish FAQ, the system displays a link beside the content to which the FAQ is related on the Launcher page (Launcher as in FIG. 3). The user can elect to click on the link and view the published FAQ at any time, without having to view the content for which the question was originally asked.

In an alternate embodiment of the invention, if an Administrator has associated a Quiz Question with the multimedia presentation, the system pauses the presentation and displays the question to the current viewer at the time point designated by the Administrator. The viewer must then answer the question before the system will permit the presentation to proceed. When a user/viewer submits an answer to a Quiz Question, the system evaluates the response and displays an Answer page with the correct answer as well as the answer provided by the user. The system can also display clarifying text along with the viewer's answer to provide additional context or reinforcement of the correct answer.

Processing Questions. Different content and sections or content can be assigned to different administrators. The submitted question or other user input is reviewed by the administrator and answered or referred to a Subject Matter Expert or someone qualified to answer the question or provide feedback. The administrator and/or the qualified person can use the time point information in the system to review the multimedia training at or near the exact time point that the input was originally entered to determine the context of the question and gain insight into what prompted the question. The administrator can compose the answer to the question over a period of time and in multiple sessions before publishing the original question and answer and thereby making the information available in the production training system.

The question and answer are published and reference the time point in the training that the user originally asked the question. Subsequent viewings of the training materials display a graphical or textual indication that a question was asked at that point in the timeline and the system allows the user to view—or hear—the question and the published answer. If a user elects to view the question, the system pauses the training and displays the question that was asked and the answer that was provided. If there are multiple questions asked within a small, defined period of time (e.g. 5 seconds), the system displays all of the questions and answers for the period together to prevent excessive interruptions to the user.

The configurable system provides highly tailored presentation and interactivity, according to user role, training objective, user behavior, jurisdiction (by state or country), and other governable factors. The system can be configured to selectively display the questions or other input to subsequent viewers, depending on the users role. For example, if a question has relevance for a specific group or groups of people, subsequent viewers of that role or type can be displayed the content without requiring all users to see the new content. In this way, the system can prevent overloading some viewers with content that is not relevant to their position, duties, or interests. The user's role, type, or location is determined at the time that the user logs into the system.

It is also possible that many other types of input/information/resources can be interactively collected and associated to the multimedia timeline that is not necessarily submitted by users. Some examples include: References to additional resources (e.g. articles, supporting documents, research documents, books, etc.) Quizzes—to ensure that viewers are retaining the knowledge through quizzes or questions that are placed in context with the material being viewed. Participatory Questions—to break up the training material and emulate what happens in real-world meetings where things like trivia questions may be asked. This would, in effect emulate the Audience Response Systems currently in use at conferences and meetings. Survey Questions—to capture the viewer's feelings at the point of contact with the materials. Clarification Materials—at key points in the multimedia timeline where viewers are generating a lot of questions or where there is confusion regarding the subject matter. Correction Notices—inserted at the point where mistakes have been made or changes are required to the content that do not substantially change what was originally captured but are required for accuracy.

Customization. These types of interactive content can also be displayed based on the user's role or location so that only the appropriate material is displayed to each user. The user's role, type, or location can be determined at the time that the user logs into the system. For example, a Principal Investigator on a clinical trial may need to have deep knowledge and understanding of the protocol and not need to master data capture in an Electronic Data Capture (EDC) system. The Study Coordinator on the other hand is required to understand the EDC tool in addition to understanding the protocol. The Principal Investigator would only be required to answer questions about the protocol whereas the Study Coordinator would have to answer the questions about the Protocol as well as questions about the EDC tool. All of this content would be placed at the appropriate point in the timeline and displayed to the correct type of user during viewing.

In addition, the administrator can configure the system for the following options, depending on the content and the required behavior: for every user of the correct role or type, only display the materials once per viewing, regardless of whether the answer provided is correct or not; for each user of the correct role or type, display the materials each time the user views the material until the user gets the answer correct; for each user, display the content each time the user views the material; randomly select a specified percentage or number of users to view the content.

The system can be configured to provide additional clarification in the event a user incorrectly answered, or supplemental information to a correct response. Interactive content can also be displayed based on viewer behavior that can be derived from the user's responses during interaction with the system. In this way, the system can adapt the display behavior based on the user's responses and answers. The system can automatically adjust the number of questions asked of a user based on that user's success rate with earlier questions. For example, depending on a user answers a question correctly or incorrectly, the system can permit the user to move on, or require the user to answer further questions.

In some cases, content that is being displayed is used across different countries and/or different jurisdictions. In these cases, there may be different answers for questions that are asked based on the user's location. The system can determine the user's location from their account information and display the appropriate question at the appropriate time. In this way, multimedia that was previously not re-usable in different countries and jurisdictions can be used and appropriate clarifications embedded in the video timeline to address the differences rather than having different multimedia versions.

It can be appreciated that various embodiments of the invention taught herein, whether or not expressly discussed hereinabove, may occur to those of skill in the relevant art and are to be deemed within the scope of the claimed invention. Further, the invention is not to be construed as limited to the examples provided herein. While the preferred embodiment is computer implemented training involving display and audio-visual multimedia, user devices which accept and delivery alternate interactivity modes are included. Any user device compliant, for example, with the American with Disabilities Act, section 508, is intended to be included in the invention. Combinations of non-manual user interactivity, as well as alternate Administrator activity, especially with regard to response to user input, such as, for example, simultaneous back channel response through applications such as Twitter, are also to be included. Finally, the invention may be on an extranet or an intranet, and the server functionalities articulated may be virtual, resident, or distributed, or any configuration. The creation of training modules and content may be by means other than through videotaping a live meeting. While the invention is described as providing the equivalent of the training provided at an Investigator Meeting, it includes satisfaction of such other training requirement that may be imposed by clinical trial or other protocol, or by other civil or legal authority, is deliverable via the system. Finally, it can be appreciated that the while the preferred embodiment and application described is compliance with clinical trial protocol requirements, any application which requires verifying user attendance to material delivery, and wherein said user attendance is monitored, recorded and verified may fall within the scope of the invention.

We claim:

1. A system for providing a substantive equivalent of an Investigator Meeting in a clinical trial, using training materials delivered to User on-line by means of a computer network, and wherein training material includes a variety of materials synchronized into training modules that can be streamed of downloaded across a network to a user device, said system comprising:
a means for networking servers and user devices, wherein said servers include one or more application servers, content servers, database servers, web servers; and
user devices, where said user devices provide interactive connectivity to said training material, and wherein said training material provides the substantive equivalent of attendance at an Investigator Meeting.

2. The system of claim 1 wherein said network includes an intranet.

3. The system of claim 1 wherein said network includes an extranet.

4. The system as in claim 1 wherein the system is further comprised of two user-facing components, said components denominated the Launcher and the Player, such that the system displays the Launcher after User log-in, and said Launcher displays to User content, said content including said training materials, and enables User to initiate delivery of content, whereupon said Player commences delivery of said content.

5. The system as in claim 4 wherein said content is comprised of one or more of audio and visual components.

6. The system of claim 4 wherein user attention to content is tracked, verified and recorded.

7. The system of claim 6 wherein a Watch Code tracks, verifies and records user attention to content.

8. The system as in claim 6 wherein the completion of training for all site personnel at a clinical trial investigation site is tracked, verified and recorded such that compliance with site training is verified and patient enrollment in said clinical trial at said Site may commence.

9. The system as in claim 8 further including tracking, verifying and recording completion of review of a clinical trial protocol amendment.

10. A method of satisfying the training requirement for clinical trial site participation by providing, through a computer implemented delivery of content, said content including training materials substantively equivalent to an Investigator Meeting, and by ensuring all site personnel have complied with receiving and reviewing all required material, so as to expedite commencement of clinical trial patient enrollment, and to ensure compliance with protocol amendments by a site, said method comprising the steps of:
providing Investigation Site personnel the option of computer implemented delivery of content denominated “online training”;
tracking, monitoring and recording said online training of Investigation Site personnel; and
commencing, upon satisfaction of Investigation Site personnel of the requirement to either attend an Investigator Meeting, Site Initiation Visit, or to complete online training, to recruit and enroll patients at said Investigation site.

11. A method as in claim 10 wherein said online training provides the substantive equivalent of attendance at an investigator Meeting, and wherein said online training is comprised of training material of one or more media elements, and where said media elements includes a variety of materials synchronized into training modules that can be streamed or downloaded across a network to a user device.

12. A method as in claim 11, further including a method of dynamically enriching media elements, where such enrichment includes interactively collecting input from users at time points during a training session delivered over a network.

13. The method as in claim 12 wherein said time points are user determined.

14. The method as in claim 12, wherein said user input includes questions, and wherein answers to said questions appear to at least one user associated with the user determined time of input.

15. A method as in claim 14, wherein said answers appear as FAQ during the training session and are optionally viewable by any user.

16. A method as in claim 12 wherein said dynamic enrichment is delivered in response to user role and user attributes as determined by user log-in.

17. A method as in claim 12 wherein said time points are pre-set and appropriate user input in response to enrichment media is a requirement for advancement of said training materials.
